(19) United States
(12) Patent Application Publication
(10) Pub. No.: US 2025/0339817 A1
(43) Pub. Date: Nov. 6, 2025

(54) A PROCESS FOR THE NITRIC OXIDE ABATEMENT THROUGH BIOLOGICAL TREATMENTS

(71) Applicants: FUNDACIÓ EURECAT, CERDANYOLA DEL VALLÈS (ES); UNIVERSITAT POLITÈCNICA DE CATALUNYA, BARCELONA (ES)

(72) Inventors: DAVID FERNANDO CUBIDÉS PÁEZ, BARCELONA (ES); IRENE JUBANY GÜELL, MANRESA (ES); XAVIER GAMISANS NOGUERA, MANRESA (ES); XAVIER GUIMERÀ VILLALBA, TERRASSA (ES)

(21) Appl. No.: 18/868,899

(22) PCT Filed: May 24, 2023
(86) PCT No.: PCT/EP2023/063868

§ 371 Date: Nov. 25, 2024

(30) Foreign Application Priority Data
May 25, 2022 (EP) 22382501.9

(51) Int. Cl. B01D 53/84; B01D 53/14; B01D 53/56; B01D 53/78

(52) U.S. Cl. CPC B01D 53/84; B01D 53/1456; B01D 53/1493; B01D 53/56; B01D 53/78; B01D 2252/103; B01D 2257/404

(57) ABSTRACT

A method for removing NOx gases from a gas stream, which includes:
i) contacting the gas stream with a solvent system which comprises a non-aqueous phase liquid (NAP) that is capable of acting as NOx gas-liquid mass transfer vector; and
ii) subjecting the solvent system of step i) to microbial denitrification, wherein NOx is selected from nitric oxide (NO), nitrogen dioxide (NO₂), and a mixture thereof. The NAP has a molecular weight from 150 to 550 g/mol and a boiling point from 400 to 700 K. The use of the NAP for removing NOx gases from a gas stream.

This application claims the benefit of European Patent Application 22382501.9 filed on May 25, 2022.

### TECHNICAL FIELD

The present invention relates to the technical field of NOx removal from gaseous effluents. In particular, it relates to a process for the nitrogen oxide abatement through biological treatments using a non-aqueous phase liquid (NAP) as NOx gas-liquid mass transfer vector.

### BACKGROUND ART

Worldwide production and industrial use of artificial nitrogen fertilizers, fuel combustion and agriculture have led to a massive acceleration in the nitrogen cycle generating chemical changes in the atmosphere due to increased emissions of nitrogen trace gases, such as nitric oxides (NOx) and ammonia (NH₃). As a consequence, in the last decades, only 30 to 60% of the produced non-reactive nitrogen species (Nr) was a result of natural processes.

The NOx present in combustion flue gas emissions is composed of approximately 90 to 95% of NO, while the remaining 5 to 10% is NO₂. In terms of air quality, high emissions of NOx contribute to both eutrophication and acidification of ecosystems and can lead to negative health effects such as chronic bronchitis, asthma, and chronic obstructive pulmonary disease. Consequently, government entities are imposing increasingly strict regulations regarding the emissions of these pollutants.

Strategies developed for controlling industrial NOx emissions include the pre-treatment of feeding materials and modifications in the combustion processes, both of which serve as preventive measures aimed at minimizing NOx emissions. Nonetheless, due to the tightening of air quality laws and the high concentrations of NOx that may be generated by combustion processes, it is necessary to implement post-treatment or end of pipe techniques where NOx are eliminated from the flue gasses after their formation in the combustion chamber.

Currently, the main physicochemical post-treatment technologies being used for controlling NOx emissions from combustion gases include selective non catalytic reduction (SNCR), selective catalytic reduction (SCR), wet and dry scrubbing and adsorption. However, some of these techniques have drawbacks such as high operational or capital cost and high environmental impact due to the large amounts of hazardous waste (secondary pollutants) that they generate which cannot be used to create valuable products.

Biological treatments of NOx are now seen as an alternative to traditional physical-chemical technologies because they are cost-effective and reduce the secondary pollutants generation, thus being more environmentally sustainable. The most widely studied biological technology for the treatment of NOx is biofiltration. This technique is based on the application of nitrification and denitrification processes.

However, when biofiltration is applied to NO removal, which has very low solubility in water, relatively high contact times (above 1 min) are required to obtain good removal efficiencies, resulting in high reactor volumes. For this reason, several alternatives are being developed to enhance NO mass transfer and optimize bioreactor performance.

One of the bio-based alternatives is the chemical absorption and biological reduction (CABR) process, which includes a previous stage to the biological reduction of NO were a chemical absorption or complexation step takes place through the use of either a mass transfer vector or a chelating agent. Also, technologies such as membrane biological reactors (MBR) that are commonly used in water treatment have been implemented. In addition to changing the types of reactors and processes, researchers have also investigated different bio-based alternatives. These included microalgae, which use NO as a nitrogen source and anaerobic ammonium oxidizing bacteria (Anammox®) which can use NO as an electron acceptor.

For CABR systems, the most widely used chelating agent has been Fe(II)EDTA²⁻. This compound reacts with NO to produce a nitrosyl complex. However, besides the complexation reaction, another undesired reaction can occur since Fe(II)EDTA²⁻ can be oxidized due to the presence of oxygen to form Fe(Ill)EDTA-, which does not bind to NO. A further disadvantage of this system is that the chelating agent needs to be regenerated before it can be used again. Despite of the fact that other studies have focused on other iron chelators, there is no evidence in the literature that bio-based technologies using iron complexes have been implemented on an industrial scale probably due to the instability of the chelating agents. Besides, cobalt-based complexes have also been investigated as an option for NO complexation. However, only few batch experiments were performed and none at pilot scale.

Furthermore, the ability of silicon oil as a mass transfer vector for the enhancement of nitrous oxide (N₂O) removal in denitrifying batch assays using a Paracoccus denitrificans culture as inoculum has also been disclosed in Chapter 7 of the PhD thesis by Osvaldo Frutos (2018). However, the authors conclude that no significant enhancement was observed in N₂O removal regardless of the fraction of silicon oil used.

Therefore, from what is known in the art it is derived that there is still the need of providing a process for the removal of NOx from flue gases which overcome the problems of the prior art and can be used on an industrial scale.

### SUMMARY OF INVENTION

The present inventors have found that non-aqueous phase liquids (NAPs) having specific molecular weights and boiling points can be effectively used as NOx gas-liquid mass transfer vectors even in the presence of CO₂, which as shown in the examples does not significantly interfere with the selectivity of NAP. Therefore, they are useful for removing NOx gases from a gas stream such as flue gas, in particular in Chemical Absorption-Biological Reduction (CABR) systems, with high efficiency.

Further, the NAPs used in the method of the invention have the advantage that they are not toxic, and therefore can be used safely. They are also biocompatible with the microorganisms commonly used in the biological reduction step. Additionally, some of them are non-biodegradable at short term and only slightly biodegradable at long term and do not undergo any reactions when acting as NOx mass transfer vector. Besides, their immiscibility with the microorganism-containing phase facilitates their separation and recovery. Therefore, they can be directly reused after their use without the need of regenerating them.

Thus, a first aspect of the invention relates to a method for removing NOx gases from a gas stream, which comprises:
i) contacting the gas stream with a solvent system which comprises a non-aqueous phase liquid (NAP) that is capable of acting as NOx gas-liquid mass transfer vector; and
ii) subjecting the solvent system of step i) to microbial denitrification,
wherein NOx is selected from nitric oxide (NO), nitrogen dioxide (NO₂), and a mixture thereof, and the NAP has a molecular weight from 150 to 550 g/mol and a boiling point from 400 to 700 K at 101300 Pa.

A second aspect of the invention relates to the use of a non-aqueous phase liquid (NAP) for removing NOx gases from a gas stream, in particular in a Chemical Absorption-Biological Reduction (CABR) system, wherein the NAP is capable of acting as NOx gas-liquid mass transfer vector, has a molecular weight from 150 to 550 g/mol, a boiling point from 400 to 700 K at 101300 Pa, and a water solubility equal to or lower than 0.1 g/L at 298 K and 101300 Pa; wherein NOx is selected from nitric oxide (NO), nitrogen dioxide (NO₂), and a mixture thereof.

### BRIEF DESCRIPTION OF THE DRAWINGS

FIG. 1 shows the removal efficiency (RE) and the percentage of oxidation of NO in the presence of pure diethyl sebacate (2), 1,1,1,3,5,5,5-heptamethyl trisiloxane (3), n-hexadecane (4), 2,2,4,4,6,8,8-heptamethyl nonane (5), or silicone oil (6), versus blank (1).

FIG. 2 shows the reduction of NO (moles of eliminated NO) in the presence of pure 1,1,1,3,5,5,5-heptamethyl trisiloxane (1), 2,2,4,4,6,8,8-heptamethyl nonane (2), and n-hexadecane (3), diethyl sebacate (4), and silicone oil (5), increasing the molarity of each mass transfer vector.

FIG. 3 shows the removal efficiency (RE) of NO in aqueous-NAP mixtures containing diethyl sebacate (2), 1,1,1,3,5,5,5-heptamethyl trisiloxane (3), n-hexadecane (4), 2,2,4,4,6,8,8-heptamethyl nonane (5), or silicone oil (6), versus blank (1).

FIG. 4 shows the removal efficiency (RE) of NO in buffered solutions containing diethyl sebacate (2), 1,1,1,3,5,5,5-heptamethyl trisiloxane (3), n-hexadecane (4), 2,2,4,4,6,8,8-heptamethyl nonane (5), or silicone oil (6), versus blank (1).

FIG. 5 shows the removal efficiency of NO with biomass with a concentration of 1.09 g/L (1) or 1.88 g/L (2) and 2.5 mL of blank, NRB or NAP (B: blank, NRB: Nitrate/Nitrite Reducing Bacteria, HTX: 1,1,1,3,5,5,5-heptamethyl-trisiloxane, HNO: 2,2,4,4,6,8,8-heptamethyl nonane, HEX: n-hexadecane).

FIG. 6 shows the concentration of nitrate in three experiments in 1 hour and 24 hours in the system with NRB-HTX (B: blank, VSS: Volatile suspended solids).

FIG. 7 shows the concentration of nitrite in three experiments in 1 hour and 24 hours in the system with NRB-HTX (B: blank, VSS: Volatile suspended solids).

FIG. 8 shows a system reactor configuration of an embodiment of the invention: absorber (1), bioreactor (2), settler (3), flue gas (4), gas without NOx (5), NOx+NAP (6), N₂ (7), biomass recirculation (8), nutrients for biomass growth and reagents for pH control (9), NAP recirculation+buffer solution (10), and purge (11).

FIG. 9 shows a system reactor configuration of another embodiment of the invention: absorber+bioreactor (1), flue gas (3), nutrients for biomass growth and reagents for pH control (4), biomass purge (5), NAP+biomass+buffer solution (6), gas without NOx (7), NAP recirculation (8), and wastewater purge (9).

FIG. 10 shows the CO₂ percent of area reduction (% AR), (directly related to CO₂ removal) for the tests in a two-phase system with pure CO₂ gas (black) and with a gas mixture of NO and CO₂ (gray) compared to blank (B), HEX: n-hexadecane, HNO: 2,2,4,4,6,8,8-heptamethyl nonane, HTX: 1,1,1,3,5,5,5-heptamethyl-trisiloxane).

FIG. 11 shows the NO percent of area reduction (% AR) (directly related to NO removal) for the tests in a two-phase system with a gas mixture of NO and CO₂ (gray) compared to blank (B), HEX: n-hexadecane, HNO: 2,2,4,4,6,8,8-heptamethyl nonane, HTX: 1,1,1,3,5,5,5-heptamethyl-trisiloxane).

FIG. 12 shows percent of area reduction (% AR) for NO (directly related to NO removal) in a three-phase system with CO₂ (black) and without CO₂ (grey) compared to blank (B), under the same experimental conditions with the addition of an aqueous phase (phosphate buffer). HEX: n-hexadecane, HNO: 2,2,4,4,6,8,8-heptamethyl nonane, HTX: 1,1,1,3,5,5,5-heptamethyl-trisiloxane).

FIG. 13 shows the analysis of the concentration nitrogenous compounds in the liquid phase in a three-phase system (CO₂/NO/Aqueous/NAP) compared to the NAP-free blank (B). HEX: n-hexadecane, HNO: 2,2,4,4,6,8,8-heptamethyl nonane, HTX: 1,1,1,3,5,5,5-heptamethyl-trisiloxane).

FIG. 14 shows the percent of CO₂ area reduction (% AR) (directly related to NO removal) for test in a three-phase with a gaseous mixture of gases (NO) and aqueous phase (phosphate buffer) compared to blank (B). HEX: n-hexadecane, HNO: 2,2,4,4,6,8,8-heptamethyl nonane, HTX: 1,1,1,3,5,5,5-heptamethyl-trisiloxane).

### DETAILED DESCRIPTION OF THE INVENTION

All terms as used herein in this application, unless otherwise stated, shall be understood in their ordinary meaning as known in the art. Other more specific definitions for certain terms as used in the present application are as set forth below and are intended to apply uniformly through-out the specification and claims.

The term “about” or “around” as used herein refers to a range of values ±10% of a specified value. For example, the expression “about 10” or “around 10” includes ±10% of 10, i.e. from 9 to 11.

The expression “substituted with one or more” means that a group can be substituted with one or more, preferably with 1, 2, 3 or 4 substituents, provided that this group has enough positions susceptible of being substituted.

For the purposes of the invention, room temperature is 20-25° C.

The term “(C₁₀-C₂₀)hydrocarbon” refers to a saturated or unsaturated branched or linear hydrocarbon chain which contains from 10 to 20 carbon atoms and optionally one or more double bonds and/or one or more triple bonds. Thus, the term “(C₁₀-C₂₀)hydrocarbon” encompasses “(C₁₀-C₂₀)alkanes”, “(C₁₀-C₂₀)alkenes”, and (C₁₀-C₂₀)alkynes”. It also encompasses hydrocarbon chains which comprise single, double and triple bonds.

The term “(C₁₀-C₂₀)alkane” refers to a saturated branched or linear hydrocarbon chain which contains from 10 to 20 carbon atoms and only single bonds. Non-limiting examples of alkane groups include n-decane, n-undecane, n-dodecane, n-hexadecane, n-heptadecane, or n-octadecane. The term “(C₁₀-C₂₀)alkene” refers to an unsaturated branched or linear hydrocarbon chain which contains from 10 to 20 carbon atoms and at least one or more double bonds. The term “(C₁₀-C₂₀)alkyne” refers to an unsaturated branched or linear hydrocarbon chain which contains from 10 to 20 carbon atoms and at least one or more triple bonds.

The term “(C₁-Cₙ)alkyl” refers to a saturated branched or linear hydrocarbon chain which contains from 1 to n carbon atoms and only single bonds. Non-limiting examples of alkyl groups include methyl, ethyl, propyl, butyl, isopropyl, 1-methylpropyl, 2-methylpropyl, pentyl, hexyl, heptyl, octyl, nonyl, decyl, undecyl or dodecyl.

The term halogen means fluoro, chloro, bromo or iodo.

The term “di(C₁-C₁₀)alkyl(C₁-C₁₀)ester” as used herein refers to a saturated or unsaturated branched or linear (C₁-C₁₀)hydrocarbon chain as defined above which is substituted at both ends of the chain with a —COO(C₁-C₁₀)alkyl radical. Non-limiting examples of di(C₁-C₁₀)alkyl(C₁-C₁₀)ester groups include diethyl sebacate or dioctyl sebacate.

The term “(C₁-C₁₂)ketone” as used herein refers to a saturated or unsaturated branched or linear (C₁-C₁₀)hydrocarbon chain as defined above which comprises in its chemical structure a —CO— moiety. Non-limiting examples of (C₁-C₁₂)ketones include 2-decanone or 2-undecanone.

The term “siloxane” as used herein refers to branched or linear organosilicon oxide polymers, also known as organopolysiloxanes, which comprise the repeating structural unit —(R₂—Si—O)—, where R is a monovalent organic radical (for example, (C₁-C₆)alkyl e.g. methyl or C₆aryl e.g. phenyl), and the end groups are trimethylsilyl groups (—Si(CH₃)₃). Non-limiting examples of siloxanes include 1,1,1,3,5,5,5-heptamethyl trisiloxane or silicon oil.

The term “Chemical Absorption—Biological Reduction (CABR) system” as used herein refers to an integrated system which comprises an absorber, wherein chemical absorption of the NOx from a gas stream is carried out, and a bioreactor, wherein the biological reduction step takes place, in particular a microbial denitrification which convert the absorbed N species into elemental nitrogen.

A mentioned above, the first aspect of the invention relates to a method for removing NOx gases from a gas stream. As used herein, the term “method for removing” refers to a method for the complete or partial elimination (i.e. reduction of the initial amount, abatement) of NOx from a gas stream.

According to one particular embodiment, optionally in combination with one or more features of the various embodiments described above or below, the NOx contained in the gas stream is completely eliminated by the process of the invention.

According to another particular embodiment, optionally in combination with one or more features of the various embodiments described above or below, from 40 to 100 mol %, more particularly from 60 to 100 mol %, and even more particularly from 90 to 100 mol % of NOx is eliminated from the gas stream, wherein the % are expressed in moles with respect to the total moles of NOx initially contained in the gas stream.

For the purposes of the present invention, the term “gas stream” as used herein refers to any gas stream, such as flue gas, which contains undesired NOx, wherein the term “NOx” relates to nitric oxide (NO), nitrogen dioxide (NO₂), or mixtures thereof.

In one particular embodiment, optionally in combination with one or more features of the various embodiments described above or below, the gas stream is a multicomponent gas mixture, more particularly the gas stream is a multicomponent gas mixture comprising carbon dioxide (CO₂), oxygen (O₂), nitrogen (N₂), sulfur oxides (SOx) and nitric oxides (NOx), and even more particularly, the gas stream is a flue gas stream.

The term “flue gas” as used herein refers to an exhaust gas from any sort of combustion process (including for example coal, oil, natural gas, petrochemical compounds, waste, or biomass). Typically, a flue gas stream contains from 4% to 13% (v/v) carbon dioxide (CO₂), from 2% to 10% (v/v) oxygen (O₂), from 77% to 82% (v/v) nitrogen (N₂), from 0.01% to 0.03% (v/v) nitric oxides (NOx), and from 0.01% to 0.05% (v/v) sulfur oxides (SOx), wherein the % are expressed in v/v with respect to the total volume of the gas mixture (Jin et al., 2005). The compounds contained in a flue gas and their concentration may vary depending on fuel composition, combustion system and operating conditions such as temperature and pressure.

In one particular embodiment, optionally in combination with one or more features of the various embodiments described above or below, the initial gas stream comprises NOx in an amount from 0.005% (v/v) to 0.1% (v/v), particularly from 0.01 to 0.05 (v/v) mol %, with respect to the total moles of the gas stream. In a more particular embodiment, NOx consists of NO. In another more particular embodiment, NOx consists of a mixture of NO and NO₂, even more particularly NOx consists of a mixture of NO and NO₂ in a NO:NO₂ molar ratio from 90:10 to 95:5.

The first step of the process of the invention comprises contacting the gas stream with a solvent system which comprises a non-aqueous phase liquid (NAP) that is capable of acting as NOx gas-liquid mass transfer vector.

For the purposes of the invention, the term “NOx gas-liquid mass transfer vector” refers to the liquid substance (i.e. the NAP) that is capable of capturing or absorbing NOx from a gas stream in such a way that a significant concentration of NOx contained in the gas stream (i.e. an amount equal to or higher than 50 mol %, particularly equal or higher than 60%, is removed with respect to the initial content) or the NOx is completely eliminated and is absorbed into this liquid substance (NAP). The skilled person can easily know if a substance is a NOx mass transfer vector by carrying out absorption tests including contacting a gas stream containing NOx with the substance and measuring the NOx content in the resulting gas stream as illustrated in the examples below.

According to one particular embodiment, optionally in combination with one or more features of the various embodiments described above or below, the NOx absorption capacity of the NAP is at least 0.1 mol NOx/kmol NAP, more particularly from 0.1 to 1 mol NOx/kmol NAP, and more particularly from 0.1 to 0.6 mol NOx/kmol NAP.

The term “NOx absorption capacity” as used herein refers to the amount of a given NAP that is needed to absorb a given amount of NOx and is expressed as mol of absorbed NOx per kmol of NAP. The skilled person can easily measure the absorption capacity of a NAP as disclosed in the examples herein by contacting a gas stream containing NOx with a specific amount of NAP and measuring the absorbed NOx. The absorbed NOx corresponds to the subtraction of the initial amount of NOx contained in the gas stream and the final amount of NOx.

The term “non-aqueous phase liquid (NAP)” as used herein refers to organic liquids having a molecular weight from 150 to 550 g/mol and a boiling point from 400 to 700 K at 101300 Pa. Non-limiting examples of NAPs include diethyl sebacate (CAS RN: 110-40-7), 2,2,4,4,6,8,8-heptamethyl nonane (CAS RN: 4390-04-9), 1,1,1,3,5,5,5-heptamethyl trisiloxane (CAS RN: 1873-88-7), n-hexadecane (CAS RN: 544-76-3), n-dodecane (CAS RN: 112-40-3), 2-undecanone (CAS RN: 112-12-9), n-heptadecane (CAS RN: 629-78-7), n-octadecane (CAS RN: 593-45-3), silicone oil (CAS RN: 63148-62-9), dioctyl sebacate (CAS RN: 2432-87-3), or perfluoromethyldecaline (CAS RN: 306-92-3).

In one particular embodiment, optionally in combination with one or more features of the various embodiments described above or below, the NAP has a molecular weight from 170 to 530 g/mol, more particularly from 200 to 520 g/mol, more particularly from 210 to 430 g/mol, and even more particularly from 220 to 410 g/mol.

In another particular embodiment, optionally in combination with one or more features of the various embodiments described above or below, the NAP has a boiling point from 400 to 700 K, more particularly from 405 to 600 K, even more particularly from 410 to 590 K, and even more particularly from 415 to 585 K, at 101300 Pa.

The NAPs used in the method of the invention can be slightly miscible or immiscible in water. When the NAP is immiscible in water it has the advantage that it facilitates the phase separation from water. In one particular embodiment, optionally in combination with one or more features of the various embodiments described above or below, the NAP has a water solubility equal to or lower than 0.1 g/L, or equal to or lower than 0.01 g/L, or equal to or lower than 0.0002 g/L, or equal to or lower than 0.0000006, or equal to or lower than 0.0000001 g/L, at 298 K and 101300 Pa.

According to one particular embodiment, optionally in combination with one or more features of the various embodiments described above or below, the NAP has a molecular weight from 150 to 550 g/mol, a boiling point from 400 to 700 K at 101300 Pa, and a water solubility equal to or lower than 0.1 g/L at 298 K and 101300 Pa; wherein NOx is selected from nitric oxide (NO), nitrogen dioxide (NO₂), and a mixture thereof.

In another embodiment, optionally in combination with one or more features of the various embodiments described above or below, the NAP is apolar. For the purposes of the invention the term “apolar” NAP refers to a NAP which does not behave as a proton donor. Typically, an apolar substance has a low HLB (hydrophilic-lipophilic balance) value; in particular equal to or lower than 8, more particularly equal to or lower than 4, and even more particularly particular equal to or lower than 2.

In another particular embodiment, optionally in combination with one or more features of the various embodiments described above or below, the NAP is selected from the group consisting of a (C₁₀-C₂₀)hydrocarbon optionally substituted with one or more halogen atoms, a di(C₁-C₁₀)alkyl(C₁-C₁₀)ester, a (C₁-C₁₂)ketone, a siloxane, perfluoromethyldecaline, and mixtures thereof. More particularly, the NAP is selected from the group consisting of a (C₁₀-C₂₀)hydrocarbon optionally substituted with one or more halogen atoms, a di(C₁-C₁₀)alkyl(C₁-C₁₀)ester, a siloxane, and mixtures thereof. Even more particularly, the NAP is selected from the group consisting of 2,2,4,4,6,8,8-heptamethylnonane, n-hexadecane, 1,1,3,3,5,5 hexamethyltrisiloxane, and diethyl sebacate.

The solvent system used in the process of the invention may comprise a NAP alone or a mixture of a NAP and an aqueous phase. In one particular embodiment, optionally in combination with one or more features of the various embodiments described above or below, the solvent system consists of a NAP. In another particular embodiment, optionally in combination with one or more features of the various embodiments described above or below, the solvent system comprises a NAP and an aqueous phase, more particularly wherein the concentration of the NAP in the aqueous phase is from 1 to 60% (v/v), more particularly from 2 to 30% (v/v), and even more particularly from 5 to 10% (v/v), with respect to the total volume of the solvent system. When present the aqueous solution may consist of water or a buffer such as phosphate buffer or carbonate buffer.

The second step of the process comprises subjecting the solvent system of step i) which contains the NOx to microbial denitrification. Microbial denitrification is a process well-known in the art. Denitrification occurs when nitrate (NO₃⁻) or nitrite (NO₂⁻) is converted in N₂ gas. This is a reductive process that is thought to occur in four stages: NO₃⁻ to NO₂⁻, NO₂⁻ to NO, NO to N₂O and N₂O to N₂ (Niu and Leung, 2010). Therefore, NO can be used as an electron acceptor so that denitrifying bacteria can reduce it to N₂ under anoxic conditions.

Any method of microbial denitrification known in the art may be used in this second step of the process, for instance, the method disclosed in the examples below. The skilled person will be able to determine operative and optimal assay conditions for carrying out the denitrification by employing routine experimentation.

Microorganisms that can be used in the denitrification step include heterotrophic bacteria of the species of Pseudomonas, Alcaligenes, and Bacillus. Non-limiting examples of microorganisms include Pseudomonas denitrificans, Deferribacter thermophilus (DSM 14813), Denitrovibrio acetophilus (DSM 12809), Bacillus infernus (DSM 10277), Bacillus simplex (DSM 1321), Bacillus thermodenitrificans (DSM 465), and Bacillus azotoformans (DSM 1046).

Generally, the denitrification step can be carried out in the presence of a denitrifying biomass, which is a biomass containing denitrifying microorganisms such as the ones disclosed herein. The term “biomass” as used herein refers to a mixture of microorganism containing several species that have specific detectable microbial activity (metabolism). In the process of the invention biomass of different origin may be used to produce the inoculum to be used for the invention. The skilled person knows how to obtain a denitrifying biomass for example from wastewater treatment plant sludge, sewage sludge, or from a bioreactor by using routine methods for enriching the denitrifying biomass such as an anoxic Sequential Batch Reactor fed with nitrite as sole electron acceptor as described in the examples.

According to one particular embodiment, optionally in combination with one or more features of the various embodiments described above or below, the microbial denitrification is carried out in the presence of an aqueous phase under anoxic conditions by the action of a microorganism capable of producing elemental nitrogen. More particularly, the microorganisms capable of producing elemental nitrogen are in the form of a biomass, and the Volatile Suspended Solid (VSS) content is from 500 to 5000 mg per litre more particularly from 1000 to 2000 mg per litre of aqueous phase. In a more particular embodiment, the biomass is obtainable from the anoxic treatment of wastewater.

For the purposes of the present invention, the term “anoxic conditions” is used herein to refer, in general, to a lack of oxygen and presence of nitrogenous species as electron acceptors for microbial metabolism. The term “volatile suspended solid (VSS)” as used herein, refers to a specific method to quantify biomass by assimilating it to the volatile part of the suspended solids, volatile part is that burned off when total suspended solid is ignited about 500-550° C.

Typically, external nutrients for biomass growth such as an external carbon source usually compounds such as acetate, glucose, lactate or VOCs such as toluene, are used for denitrification (Flanagan et al., 2002).

According to one particular embodiment, optionally in combination with one or more features of the various embodiments described above or below, a carbon source is added to the biomass such that the atomic ratio of carbon from the carbon source to nitrogen in the nitrate (C:N) is from 1:1 to 6:1, more particularly from 1:1 to 3:1.

In one particular embodiment, optionally in combination with one or more features of the various embodiments described above or below, step ii) is carried out at a temperature from 5 to 40° C., more particularly from 20 to 30° C.

In one particular embodiment, optionally in combination with one or more features of the various embodiments described above or below, step ii) is carried out at a pH from 6.5 to 9, more particularly from 8.0 to 8.5.

According to another embodiment, optionally in combination with one or more features of the various embodiments described above or below, the method of the invention is carried out under a pressure ranging from atmospheric pressure (about 101325 Pa) to 161325 Pa, more particularly is carried out under about atmospheric pressure (101325 Pa).

According to another embodiment, optionally in combination with one or more features of the various embodiments described above or below, the method of the invention further comprises step iii) recovering the NAP after step ii), in particular by separating it from the microorganisms, for example by use of a decanter or settler. The recovered NAP can be reused again in a new process for removing NOx from a gas stream.

The process of the invention can be performed in different configurations. Thus, steps i) and ii) may take place either in a single reactor, or alternatively, in different reactors.

When steps i) and ii) are performed in different reactors, there is no particular limitation on the pH or temperature conditions under which the step i) can be performed, provided that the NAP is not degraded. By contrast, when the two steps of the method of the invention are performed in the same single reactor, the pH and temperature conditions of the reactor are those compatible with the action of the microorganisms.

According to one particular embodiment, optionally in combination with one or more features of the various embodiments described above or below, steps i) and ii) of the method of the invention are performed in a single reactor, which acts as absorber and bioreactor at the same time. More particularly, the temperature of the reactor is from 5 to 40° C., more particularly from 20 to 30° C., and the pH is from 6.5 to 9, more particularly from 8.0 to 8.5.

In another particular embodiment, optionally in combination with one or more features of the various embodiments described above or below, steps i) and ii) of the method of the invention are performed in different reactors. More particularly, step i) is carried out in an absorber at a temperature from 5 to 60° C., more particularly from 20 to 30° C., and at a pH from 4 to 9, more particularly from 6.5 to 8.5, and step ii) is carried out in a bioreactor at a temperature from 5 to 40° C., more particularly from 20 to 30° C., and at a pH from 6.5 to 9, more particularly from 8.0 to 8.5.

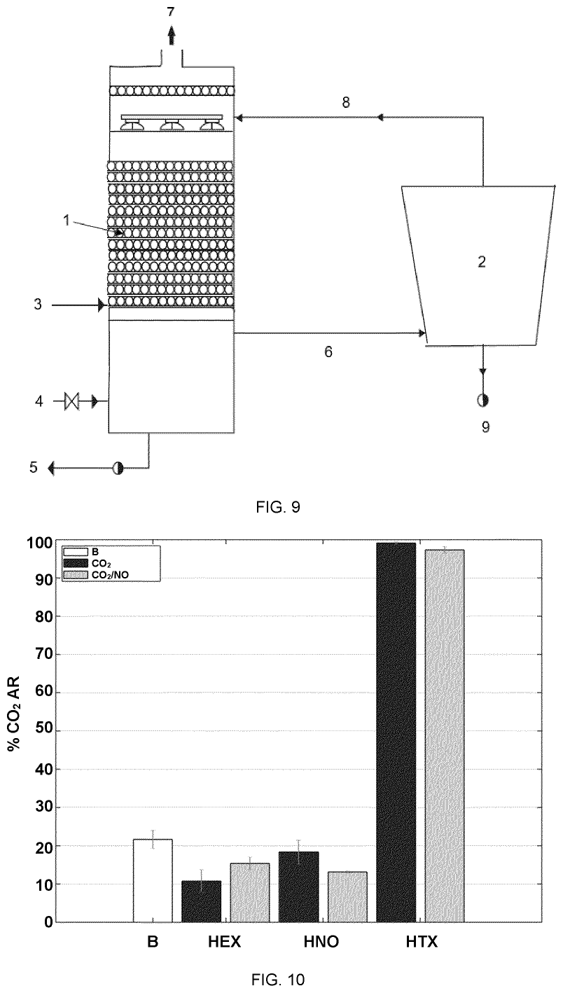

Two non-limiting examples of possible configurations are shown in FIGS. 8 and 9. In the embodiment shown in FIG. 8 there is a physical separation of the absorption of the initial gas stream (e.g. a combustion flue gas) and the subsequent biological treatment of the liquid effluent. The gas to be treated (4) enters a gas-liquid contactor (absorber, (1)), in which contaminants NOx are transferred from the gas phase to the aqueous phase using the mass transfer vector (NAP) as defined herein. The liquid effluent obtained (6) will contain the pollutant to be treated and the NAP and will enter the biological reactor (2). To separate the NAP from the biomass sludge, a settler (3) is used in which the NAP (10) is recirculated to the absorber and the biomass (8) to the bioreactor.

In the embodiment shown in FIG. 9, the flue gas (3) passes through a non-biodegradable packing material (1) through which an aqueous solution with a mass transfer vector (NAP) is continuously recirculated, which provides the necessary nutrients for microbial activity and its growth. In addition, gas/liquid mass transfer takes place. To separate the NAP from the biomass, a decanter (2) is used in which the NAP (8) is recirculated to the equipment.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples are provided by way of illustration, and they are not intended to be limiting of the present invention. Reference signs related to drawings and placed in parentheses in a claim, are solely for attempting to increase the intelligibility of the claim and shall not be construed as limiting the scope of the claim. Furthermore, the present invention covers all possible combinations of particular and preferred embodiments described herein.

### Examples

### Chemicals and Gases

NAPs: n-hexadecane (HEX, assay 99%; CAS: 544-76-3), diethyl sebacate (DES, assay 98%; CAS: 110-40-7), 1,1,1,3,5,5,5-heptamethyl-trisiloxane (HTX, assay 97%; CAS: 1873-88-7), 2,2,4,4,6,8,8-heptamethylnonane (HNO, assay 98%; CAS: 4390-04-9) and high temperature silicone oil (SO, assay 97%; CAS: 63148-52-7) of highest purity grade available were purchased at Sigma Aldrich (Lyon, France). Nitric oxide (20% in N₂) and nitrogen were purchased from Linde Gas Espana (Rubi, Catalonia, Spain). CO₂ (?99.998%) was purchased from Nippon gases Euro-Holding S.L.U (Barcelona, Catalonia, Spain).

### Biomass and Grown Conditions (Nitrate/Nitrite Reducing Bacteria, NRB)

Denitrifying biomass used in this study was obtained from an 8 litres Sequential Batch Reactor (SBR) inoculated with biomass from the anoxic treatment of municipal wastewater treatment plant (WWTP) located in Manresa, Spain. After inoculation, the denitrifying bacteria were enriched for 2 months in the Sequential Batch Reactor (SBR) that was configured to develop 2 cycles of 12 hours. Each cycle had a time of 13 minutes of filling, 11 hours and 15 minutes of anoxic reaction, 30 minutes of settle and 2 minutes of withdraw. It also had a pH control system set at pH 8 with 1 M HCl addition. At steady state the reactor had a total NO₂⁻ load of 0.8 g/L, 1.2 g/L C₂H₃NaO₂·3H_{2O}, 0.016 g/L KH₂PO₄, 0.041 g/L CaCl₂ and 1 mL micronutrients solution (0.15 g/L H₃BO₃, 0.03 g/L CuCl₂·2H₂O, 0.18 g/L KI, 0.12 g/L MnCl₂·4H₂O, 0.06 g/L NaMoO₄·2H₂O, 0.12 g/L ZnSO₄·7H₂O, 0.15 g/L CoCl₂·6H₂O and 10 g/L EDTA·Na₂O₈·2H₂O).

### 1. Experimental Set Up

1.1. Nitric Oxide (NO) Absorption with Pure NAPs

Batch tests with pure NAPs were performed in 120 mL glass amber vials with an initial concentration of NO between 4500 and 5100 ppmᵥ and different amounts of NAPs (DES, SO, HTX, HNO and HEX). For this experiment each NAP was added to a vial containing NO. Each NAP was tested alone. The results were compared with respect to a blank containing deionized water instead of NAP. All experiments were carried out at a temperature of 25° C. and agitation of 100 rpm in an incubator, five replicates were made per point. Gas phase analysis (NO and NO₂) was performed at the beginning of the experiment and at the end (1 hour).

1.2. Nitric Oxide (NO) Absorption in Aqueous Phase with NAPs

Batch tests of NAPs in contact with an aqueous phase were carried out in 500 mL glass amber bottles. Tests were performed with water and phosphate buffer at pH 8 at different ratios of NAP/aqueous phase (5,10, and 20% v/v). Initial NO concentration between 4500 and 6000 ppmᵥ was used. Vials and bottles were previously prepared in a glove box to maintain an inert atmosphere. For this experiment each NAP-water or NAP-buffer mixture was added to a vial containing NO. All experiments were carried out per triplicate at a temperature of 25° C. and agitation of 100 rpm in an incubator. The results were compared with respect to a blank (deionized water or buffer without NAP). NO and NO₂ concentrations in the gas phase were measured at the beginning and at the end of the test (1 h). Also, the phase liquid was monitored for pH, NO₂⁻ and NO₃⁻ at the end of each test.

1.3 Toxicology and Short-Term Biodegradation Test with Denitrifying Bacteria

Toxicity and biodegradability tests were performed using AER-500 respirometer (Challenge technology®) to measure the N₂ production in the denitrification process. The tests were carried out in 500 mL glass bottles using 300 mL of biomass from the SBR with a solids concentration of 0.95 TSS/L in inert atmosphere (N₂).

Toxicity tests were performed by injecting 10 mL of a solution with and excess of carbon source (21.75 g/L C₂H₃NaO₂·3H₂O, 11 g/L NaNO₂, 0.4 g/L KH₂PO₄, 1.025 g/L CaCl₂ and 25 mL trace element solution). After the solution was injected, when N₂ produced by the denitrifying activity was steady, 50 mL of each of the NAP were injected into the bottle. Each of the tests was performed in duplicate and with a control without NAP.

Short-term biodegradability tests were performed by injecting 5 mL of solution limiting the carbon source to determine if the biomass used NAPs as a carbon source (7.25 g/L C₂H₃NaO₂·3H_{2O}, 11 g/L NaNO₂, 0.4 g/L KH₂PO₄, 1.025 g/L CaCl₂ and 25 mL trace element solution). After injecting the mineral medium, when it was observed that the bacteria were producing N₂, 10 mL of each of the NAPs were injected into the bottle and N₂ was monitored for 6 h. The tests were performed in duplicate and with a control without NAP.

### 1.4. Long-Term Biodegradability Tests.

The ultimate Biochemical Oxygen Demand (BOD) tests (long-term biodegradability) were performed with OxiDirect® BOD measuring device and according to what is described in the OECD guide for testing chemical products of respirometry manometric test (301 F). Control oxygen consumption due to pressure change over 28 days was measured.

The tests were carried out in 500 mL glass bottles using 1 mL of biomass from the SBR with that gave a final solid's concentration of 0.007 TSS/L in the bottle, 156 mL of mineral medium that is described in the OECD guide, and 175 mg HEX, 4169 mg HNO, 88 mg HTX, 66 mg DES and 66 mg SO.

### 1.5. Chemical Absorption and Biological Reduction—CABR Tests

CABR batch tests were performed in 120 mL glass amber vials previously filled with N₂. Experimental conditions were a temperature of 25° C. and agitation of 100 rpm. Four replicates were made per point. Initial NO concentration between 4500 and 6000 ppmᵥ was used. Three experiments were performed varying the relationship between biomass and NAP. In the first experiment, 20 mL of biomass with a concentration of 1.09 g/L were introduced, followed by 2.5 mL of HTX, HNO and HEX in the same vial. In the second, the biomass concentration was increased to 1.88 g/L and 2.5 mL of NAP. In a last experiment, a biomass concentration of 2.7 g/L and 1 mL of each NAP were injected. NO and NO₂ concentrations in the gas phase were measured at the beginning and at the end of the test. Also, the phase liquid was monitored for pH, NO₂⁻ and NO₃⁻ at the end of each test.

### 1.6. Mass Transfer Gas-to-Liquid Tests in a Two-Phase System (CO₂/NAP)

Mass transfer gas-to-liquid batch tests were performed to determine the mass transfer rate of CO₂ in the presence of NAP. The initial samples were filled with CO₂ to reach a peak transmittance area between 6200 and 7100 cm-1, then 10 mL of each NAP (HTX, HNO and HEX) was injected. The results were compared with respect to a blank (phosphate buffer at pH 8 instead of NAP) The duration of the tests was 1 h, since preliminary studies found that the phase equilibrium within the system was reached in less than 1 h. CO₂ in the gas phase were measured at the beginning and at the end of the test. All experiments were performed in 500 mL amber glass bottles previously prepared in a glove box to maintain an inert atmosphere and carried out per at least triplicate at a temperature of 25° C. and 100 rpm orbital shaking in an incubator.

1.7 Mass Transfer Gas-to-Liquid Batch Tests in a Two-Phase System with a Mixture of Gases (CO₂/NO/NAP)

Mass transfer gas-to-liquid batch tests with a mixture of gases with CO₂ and NO were performed to determine the mass transfer rate and selectivity of these gases in the presence of NAP. The initial samples were filled with CO₂ to reach a peak transmittance area between 6388 and 8018 cm⁻¹ and NO to reach a peak of transmittance area between 73 and 84 cm⁻¹, then 10 mL of each NAP (HTX, HNO and HEX) was injected. CO₂ and NO in the gas phase were measured at the beginning and at the end of the test. All experiments were carried out per at least triplicate at a temperature of 25° C. and 100 rpm orbital shaking in an incubator. These tests had also a blank in which the NAP phase was replaced by phosphate buffer (pH=8).

1.8. Mass Transfer Gas-to-Liquid Batch Tests in a Three-Phase System with a Mixture of gases (CO₂/NO/Aqueous/NAP)

Mass transfer gas-to-liquid batch tests with a mixture of gases with CO₂ and NO were performed to determine the mass transfer rate and selectivity of these gases in the presence of NAP and aqueous phase. The results were compared with respect to blank (water or phosphate buffer at pH 8 without NAP). The initial samples were filled with CO₂ to reach a peak transmittance area between 8010 and 8940 cm⁻¹ and NO to reach a peak of transmittance area between 11 and 14 cm⁻¹, then 10 mL of each NAP (HTX, HNO and HEX) was injected. Tests were performed with a phosphate buffer at pH 8 at a 10% v/v ratio of NAP/aqueous phase. All experiments were performed in 500 mL amber glass bottles previously prepared in a glove box to maintain an inert atmosphere and carried out per at least triplicate at a temperature of 25° C. and 100 rpm orbital shaking in an incubator. CO₂ and NO in the gas phase were measured at the beginning and at the end of the test. Also, the liquid phase was monitored for pH, nitrite (NO₂⁻) and nitrate (NO₃⁻) at the end of each test.

### 2. Analytical Procedures

### 2.1. Chemical Analysis

NO and NO₂ concentrations in the gas phase were measured by Fourier Transform Infrared Spectroscopy (FTIR) from an aliquot of 1 mL (PerkinElmer Inc., Spain). The NO removal efficiency in the tests was calculated from the difference in NO concentration from the beginning and end of each test. Nitrogen compounds and chemical oxygen demand (COD) were analyzed in liquid samples after centrifuged at 15,000 rpm and filtration (0.22 μm) to separate the NAP found in the sample. Nitrite and nitrate were measured using Hach Lange kits (LCK342 and LCK 339, respectively, Hach Lange, Germany). COD was measured using Hach Lange kits (LCK114 and LCK 214, respectively, Hach Lange, Germany).

NO and CO₂ peak area in the gas phase were measured by Fourier Transform Infrared Spectroscopy (FTIR). In these experiments the peak area was analyzed and not the concentration. Therefore, the performance of the tests will be given in percent (%) area reduction, which is defined in Eq 1. Nitrogen compounds were analyzed in liquid samples after being centrifuged at 15,000 rpm and filtration (0.22 μm) to separate the NAP found in the sample. NO₂⁻ and NO₃⁻ were measured using Hach Lange kits (LCK342 and LCK 339, respectively, Hach Lange, Germany).

$$\% Area reduction = \frac{{Area}_{initial} - {Area}_{final}}{{Area}_{initial}} * 100 \qquad ( Eq . 1 )$$

The initial area (Areaᵢₙᵢₜᵢₐₗ) is a quantitative measure of the transmittance at certain given wavelengths (NO=1730-1930 cm⁻¹; CO₂=2230-2400 cm⁻¹) and correlates the presence of the compound in the sample at time=0 h. The final area (Area_{final}) is a quantitative measure of the transmittance at the given wavelengths (NO=between 1730-1930 cm⁻¹; CO₂=2230-2400 cm-1) and correlates with the presence of the compound in the sample at time=1 h.

### 2.2. Microbial Community Analysis

One inoculum sample in steady state were collected from SBR denitrifying reactor in steady state. DNA extraction from the sample was performed using the DNeasy PowerSoil Pro Kit (Qiagen, German) according to its principles and instructions and stored at −70° C. Two variable regions (V3, V4) of the 16S rRNA gene were amplified by Polymerase Chain Reaction (PCR) with the custom designed fusion primers shown in table 1.

TABLE 1

| Name and | |
|---|---|
| direction | Target 16S Primer |
| V3F | CCTACGGGRSGCAGCAG (SEQ ID NO: 1) |
| V3R | ATTACCGCGGCTGCT (SEQ ID NO: 2) |
| V4F | GTGCCAGCMGCCGCGGTAA (SEQ ID NO: 3) |
| V4R | GGACTACHVGGGTWTCTAAT (SEQ ID NO: 4) |

F forward and R reverse primers

Bobine serum albumin (BSA) was added to the PCR reaction to neutralize potential inhibitors. The PCR product, called amplicon or library, was visualized with a 2% agarose gel, purified with the NucleoSpin kit (Macherey-Nagel, Berlin, Germany) and quantified with an Agilent 2100 Bioanalyzer (Agilent Technologies, California, USA) and the Agilent High Sensitivity DNA kit (Agilent Technologies). Lastly, an equimolar mixture (60 pM) of the samples in three pools was created to be sequenced in three runs. From the equimolar mixture of libraries, the Ion 520 & Ion 530 Kit-Chef (Life Technologies, Carlsbad, California, USA) and a xip 530 were used for the sequencing of each sample group. Sequencing was performed on LifeTechnologies GeneStudio S5 equipment, using 850 flows per run. The analysis was performed using QIIME (2-2020.8).

2.3. Denitrifyinq Capacity—qPCR and Gene Expression

The same sample used to study the microbial community was used to study denitrification genes expression, RNA extraction was done with RNeasy PowerSoil Total RNA Kit (Qiagen, German) according to its principles and instructions and stored at −70° C. until analysis. From the set of primers shown in table 2, three pairs of primers were synthesized to selectively amplify the nirS, CnorB and nosZ genes.

TABLE 2

| Target | | |
|---|---|---|
| gene | Primers | Primer sequence (5′-3′) |
| nirS | nirS1F | CCTAYTGGCCGCCRCART |
| | | (SEQ ID NO: 5) |
| | nirS3R | GCCGCCGTCRTGVAGGAA |
| | | (SEQ ID NO: 6) |
| CnorB | cnorB2F | GACAAGNNNTACTGGTGGT |
| | | (SEQ ID NO: 7) |
| | cnorB7R | TGNCCRTGNGCNGCNGT |
| | | (SEQ ID NO: 8) |
| norZ | nos1527F | CGCTGTTCHTCGACAGYCA |
| | | (SEQ ID NO: 9) |
| | nos1773R | ATRTCGATCARCTGBTCGTT |
| | | (SEQ ID NO: 10) |

F forward and R reverse primers

In table above Y is C or T; R is A or G; V is A or C or G; H is A or C or T; B is C or G or T, and N is A, C, G or T (IUPAC nucleotide code). RNA samples were retrotranscribed with a commercial polymerase (Super script IV (18090050)) and assayed by real-time quantitative PCR for all 3 genes, using a Thermofisher polymerase with sybrgreen and the Applied biosystems 7900HT quantitative PCR kit.

### 3. Results

3.1. Nitric Oxide (NO) Absorption with Pure NAPs

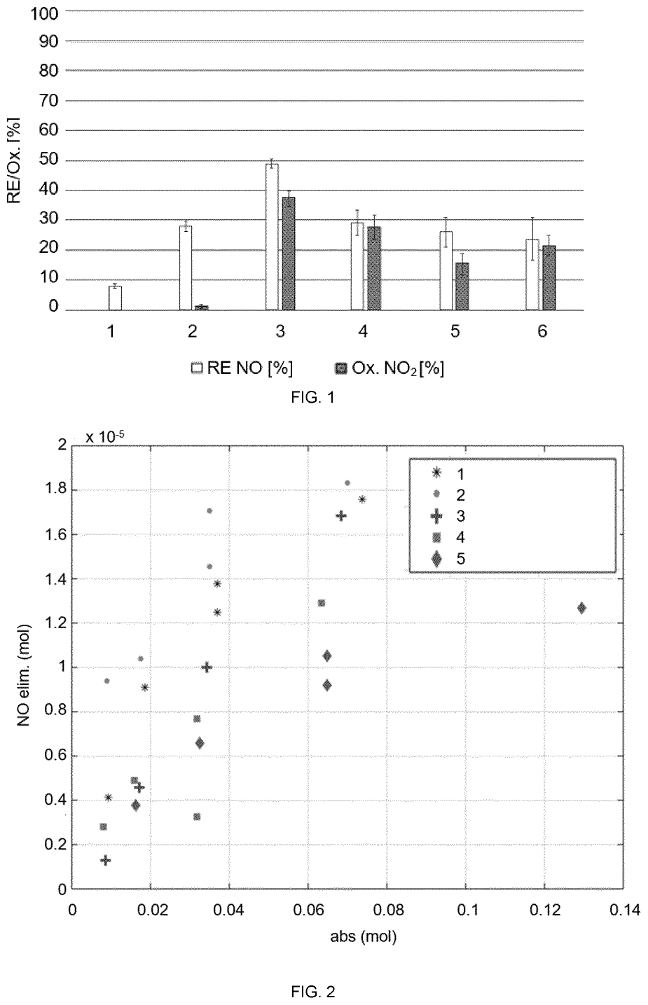

FIG. 1 shows a first screening test. Oxidation of NO to NO₂ was found when HEX, HTX, HNO and SO, were used as mass transfer vectors. In addition, with respect to diethyl sebacate, there is no evidence that there is an oxidative reaction of NO, but rather an absorption reaction. The NAPs that gave the best results were HTX with a RE NO of 49.2%, followed by HEX with a RE NO of 29.2% under the studied conditions.

FIG. 2 shows the gas-phase removal of NO in the presence of pure SO, DES, HTX, HNO and HEX increasing the molarity of each mass transfer vector. It was shown that by increasing the molarity in the different NAPs there was a greater elimination of NO and therefore, the limitation in the elimination of NO is due to the amount of absorbent that is added to the system. HTX, HNO and HEX reached a similar NO removal by adding 0.076, 0.070 and 0.068 moles of each of the absorbers, respectively.

3.2. Nitric Oxide (NO) Absorption in Aqueous Phase with NAPs

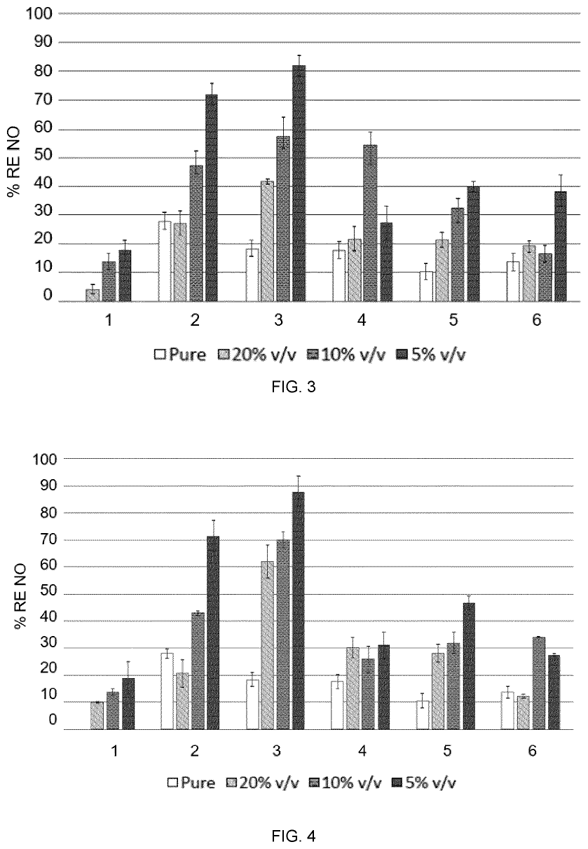

FIG. 3 and FIG. 4 show the NO absorption when the NO was contacted with a mixture of the NAP in an aqueous phase (water or buffer) at different NAP concentrations. It was observed that, in most of the NAPs, the absorption of NO was improved when an aqueous phase was mixed with the NAP in comparison with the NAPs in its pure state.

The NAPs that gave the best results in the aqueous phase were DES, HTX and HNO. Additionally, no significant difference in absorption was observed between each other if buffer or water was added.

3.3. Toxicity Test with Denitrifying Bacteria

None of the NAPs studied were found to be toxic for denitrifying bacteria with short-term tests.

### 3.4. Biodegradation Test

Short-term biodegradability tests showed that all NAP except for DES were not biodegradable. Further, it was found that the silicone oil did not degrade in the 28 days of the test and hexadecane, heptamethyl trisiloxane and heptamethyl nonane only degraded 8%, 7% and 1%, respectively, in the 28 days of the test. The test also confirmed that DES is completely biodegradable under anoxic and aerobic conditions. However, the DES that is biodegraded is used by denitrifying bacteria as a carbon source.

### 3.5. Chemical Absorption and Biological Reduction—CABR Tests

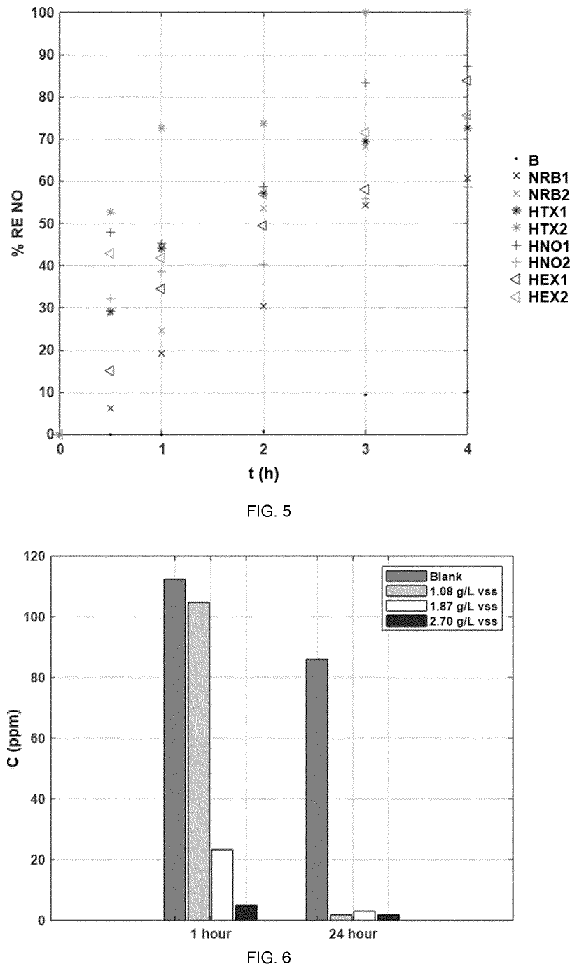

With the results of the abiotic and biotic tests, three absorbents (HEX, HNO and HTX) were chosen to study the integration of the chemical absorption and biological NO reduction system. As can be seen in FIG. 5, NO elimination was shown to improve in the short term (30 min or 1 hour) when the three mass transfer vectors and enriched denitrifying bacteria were added. It can also be seen that by increasing the biomass concentration from 1.09 g/L to 1.88 g/L, NO removal increased. For example, NRB-HTX reached 100% NO removal at three hours with a biomass concentration of 1.88 g/L, whereas with 1.09 g/L it reached only 72% RE NO.

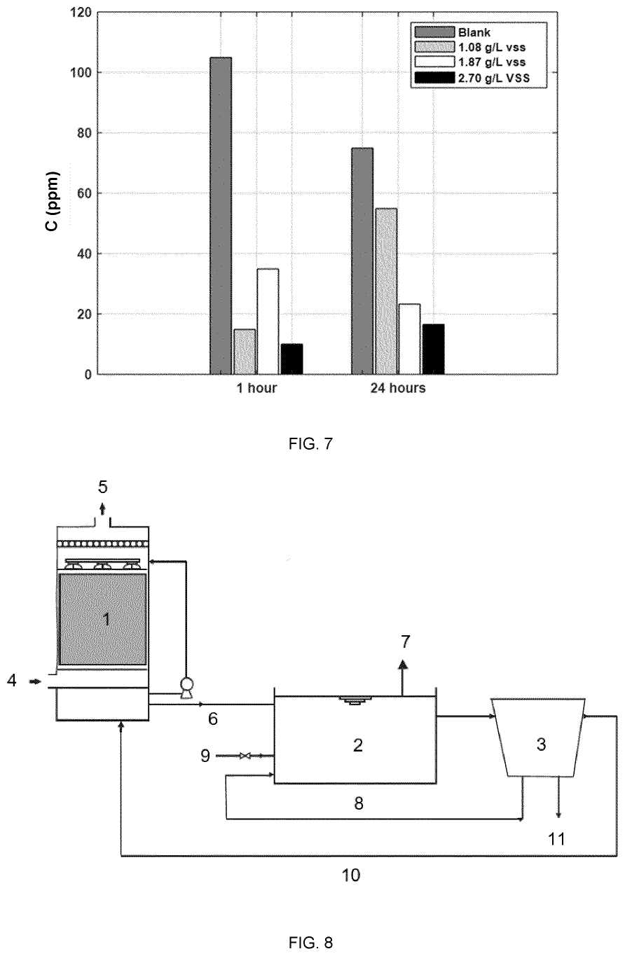

Additionally, FIGS. 6-7 show that there was no accumulation of nitrite and nitrate in the system with NRB-HTX, which confirmed that NO was oxidized to NO₂, then there was mass transfer of gas to liquid, and it was converted to nitrite or nitrate, that denitrifying bacteria consumed it in their metabolic process and converted it to nitrogen gas (N₂). The same non-accumulation in the system was evidenced for HEX and HNO.

### 3.6. Microbial Community Analysis

The microbial community structures were analysed to investigate the species existing in the CABR test (Example 1.5). In decreasing order, Thauera (14.37%), Flavobacterium (13.87%), Acinetobacter (7.90%), Cyclobacteriacea (6.41%), Fusibacter (4.41%), Pseudomonas (3.19%), Dechloromonas (2.40%), Rhodobacteraceae (2.25%), Alishewanella (1.75%) and Saprospiraceae (1.74%) were dominant in the sample. It was found that the dominant species in the system were denitrifying bacteria. Thauera, Flavobacterium and Rhodobacteraceae were reported as aerobic denitrifying bacteria and can not have inhibition by oxygen. Also, the genera Pseudomonas and Acinetobacter include the most commonly isolated denitrifying bacteria.

3.7. Denitrifying Capacity—ciPCR and Gene Expression

As shown in table 3 the most common gene detected was nosZ. The genera in which greater expression of this gene was found were: Thauera, Flavobacterium, Pannonibacter. Presence of all three genes was found in Pseudomonas (nosZ, nirS and CnorB). The genera Streptococcus, Bacillus, Legionella, Streptomyces and Corynebacterium were found to have the presence of the CnorB gene.

TABLE 3

| | Percentage of | | | |
|---|---|---|---|---|
| | abundance in | Presence of the gene in the genome | | |
| Identified Genus | the sample | nosZ | nirs | CnorB |
| Thauera | 13.95% | Present | Absent | Absent |
| Pannonibacter | 4.69% | Present | Absent | Absent |
| Flavobacterium | 4.52% | Present | Absent | Absent |
| Chryseobacterium | 0.80% | Present | Absent | Absent |
| Pseudomonas | 0.41% | Present | Present | Present |
| Rhodobacter | 0.29% | Present | Absent | Absent |
| Hyphomicrobium | 0.20% | Present | Absent | Absent |
| Paracoccus | 0.17% | Present | Absent | Absent |
| Shinella | 0.14% | Present | Absent | Absent |
| Mesorhizobium | 0.09% | Present | Absent | Absent |
| Bacteroides | 0.06% | Present | Absent | Absent |
| Bacillus | 0.05% | Present | Absent | Present |
| Streptomyces | 0.04% | Absent | Absent | Present |
| Prevotella | 0.03% | Present | Absent | Absent |
| Bradyrhizobium | 0.03% | Present | Absent | Absent |
| Legionella | 0.03% | Absent | Absent | Present |
| Streptococcus | 0.02% | Absent | Absent | Present |
| Castellaniella | 0.02% | Present | Absent | Absent |
| Ensifer | 0.01% | Present | Absent | Absent |
| Afipia | 0.01% | Present | Absent | Absent |
| Elizabethkingia | 0.01% | Present | Absent | Absent |
| Corynebacterium | 0.01% | Absent | Absent | Present |
| Luteitalea | 0.01% | Present | Absent | Absent |

This study demonstrates that when all genes were expressed, there was complete denitrification in the system. It must be said that even if a gene is present in the genome, it does not mean that it is constantly expressing it. That is, the presence of the gene in the genome does not necessarily indicate its expression because the expression of a gene occurs at a given time or under a specific stimulus.

3.8 Mass Transfer Gas-to-Liquid Tests in a Two-Phase System (CO₂/NAP) and (CO₂/NO/NAP)

FIG. 10 shows the CO₂ percent of area reduction for the tests in a two-phase system with pure CO₂ gas (black) and with a gas mixture of NO and CO₂ (gray). The NAP that gave the best result in terms of gas phase CO₂ peak area reduction was HTX (99±0.2% without gas mixture; 97±0.9% with NO/CO₂ gas mixture). From these values, it can be concluded that no significant differences were observed when NO was not present in the system. The other two NAPs (HEX and HNO) were found to have lower percentage CO₂ area differences than the phosphate blank (22±2%). Reaching CO₂ peak area differences in the presence of HEX of 11±3% without gas mixture and 15±2% with NO/CO₂ gas mixture and in presence HNO of 18±3% without gas mixture and 13±0.3% with NO/CO₂ gas mixture.

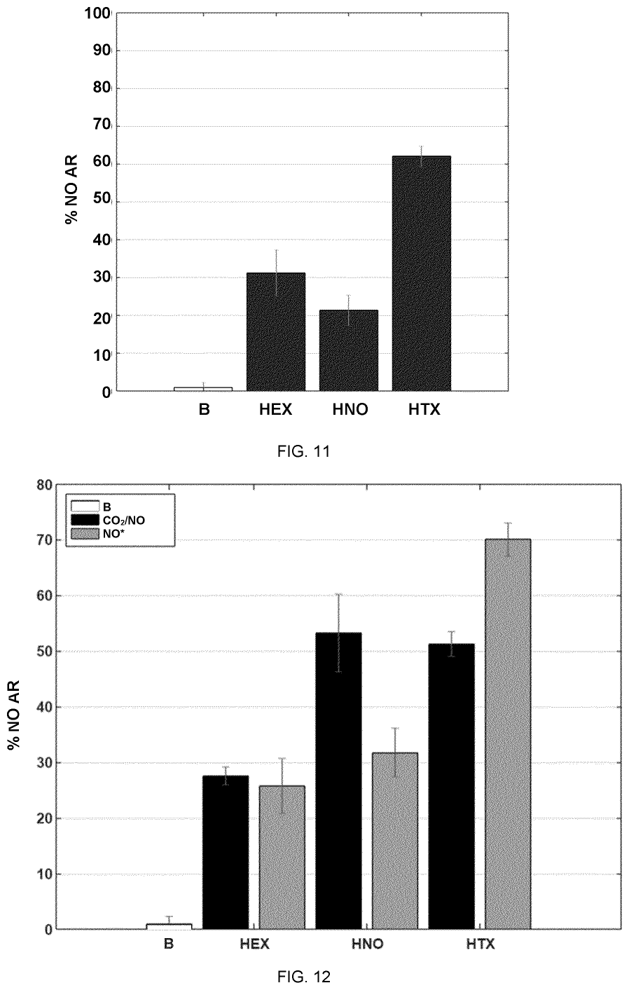

FIG. 11 shows the NO percent of area reduction for the test in a two-phase system with a gas mixture with NO/CO₂. The NAP with the best NO uptake performance was HTX with a percentage area difference of 62±5%, followed by HEX with 31±6% and HNO 21±4%. The results of FIGS. 11 and 12 give an indication that in a two-phase system the selectivity of the NAPs is more towards NO than CO₂.

3.9. Mass Transfer Gas-to-Liquid Batch Tests in a Three-Phase System with a Mixture of Gases (CO₂/NO/Aqueous/NAP)

FIG. 12 shows percent of area reduction for NO in a three-phase system with CO₂ (black) and without CO₂ (grey), under the same experimental conditions with the addition of an aqueous phase (phosphate buffer). As can be seen, for HEX there was no significant variation in the peak areas (28±3% when CO₂ was present and 26±5%). However, for HNO the variation was 54±4% with CO₂ and 32±4% without CO₂ and HTX of 56±7% with CO₂ and 70±3% without CO₂. According to the results, when an aqueous phase and CO₂ were present, even though there were changes in the differences in peak areas for NO, CO₂ did not significantly interfere with the selectivity of NAP and that in a real flue gas, the NAPs would continue to help the gas-to-liquid mass transfer for NO.

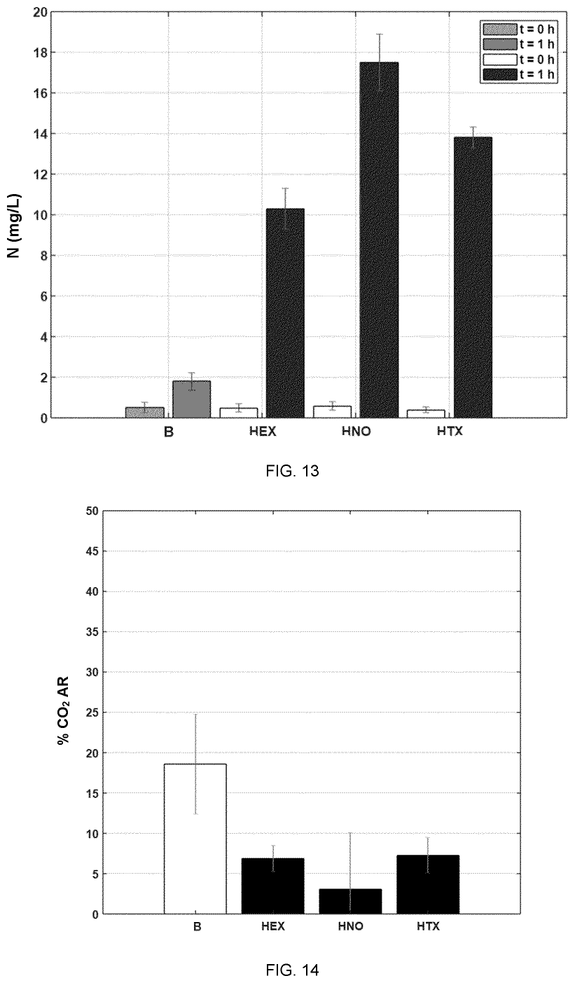

FIG. 13 shows the analysis of the liquid phase (nitrogen compounds) in a three-phase system. A higher concentration of nitrogenous compounds in the form of NO₂⁻ and NO₃⁻ was evident when either NAP was present compared to the NAP-free blanks (HEX: 10±1 N-mg/L; HNO: 18±2 N-mg/L; HTX: 14±2 N-mg/L). This confirmed that the NAPs tested improved the transfer of NO from gas-to-liquid. The results confirmed that as soluble gases (NO₂) were formed in the gas phase, they were transferred to the liquid phase through different instantaneous and irreversible reactions with phosphate buffer to form nitrous and nitric acids.

FIG. 14 shows the CO₂ peak area differences for the test in a three-phase with a gaseous mixture of gases (NO) and aqueous phase (phosphate buffer). CO₂ in the presence of NAPs was found to have an area difference less NAPs (HEX: 8±2%; HNO: 3±7%; HTX: 7±2%) than that of the phosphate blank (19±6%).

### CITATION LIST

Chapter 7 of the PhD thesis by Osvaldo Frutos (2018): “Enhancement of N₂O mass transfer in two-liquid phase systems” (page 157-162).
Jin, Y., Veiga, M. C., Kennes, C., 2005. Bioprocesses for the removal of nitric oxides from polluted air. J. Chem. Technol. Biotechnol. 80, 483-494.
Niu, H., Leung, D. Y. C., 2010. A review on the removal of nitric oxides from polluted flow by bioreactors. Environ. Rev. 18, 175-189.
Flanagan, W. P., Apel, W. A., Barnes, J. M., Lee, B. D., 2002. Development of gas phase bioreactors for the removal of nitric oxides from synthetic flue gas streams. Fuel 81, 1953-1961.
OECD guide for testing chemical products of respirometry manometric test (301F, adopted 17.07.92).

What is claimed is:

1. A method for removing NOx gases from a gas stream, which comprises:
i) contacting the gas stream with a solvent system which comprises a non-aqueous phase liquid (NAP) that is capable of acting as NOx gas-liquid mass transfer vector; and
ii) subjecting the solvent system of step i) to microbial denitrification, wherein NOx is selected from nitric oxide (NO), nitrogen dioxide (NO₂), and a mixture thereof, and the NAP has a molecular weight from 150 to 550 g/mol and a boiling point from 400 to 700 K at 101300 Pa.

2. The method according to claim 1, wherein the NAP is selected from the group consisting of a (C₁₀-C₂₀)hydrocarbon optionally substituted with one or more halogen atoms, a di(C₁-C₁₀)alkyl(C₁-C₁₀)ester, a (C₁-C₁₂)ketone, a siloxane, perfluoromethyldecaline, and mixtures thereof.

3. The method according to claim 1, wherein the NAP has a water solubility equal to or lower than 0.1 g/L at 298 K and 101300 Pa.

4. The method according to claim 1, wherein the NAP is selected from the group consisting of 2,2,4,4,6,8,8-heptamethylnonane, n-hexadecane, 1,1,3,3,5,5 hexamethyltrisiloxane, and diethyl sebacate.

5. The method according to claim 1, wherein the absorption capacity of the NAP is from 0.1 to 1 mol NOx/kmol NAP.

6. The method according to claim 1, wherein the solvent system comprises an aqueous phase and a NAP, wherein the NAP concentration is from 1 to 60% (v/v) with respect to the total volume of the solvent system.

7. The method according to claim 1, wherein the microbial denitrification is carried out in the presence of an aqueous phase under anoxic conditions by the action of microorganisms capable of producing elemental nitrogen.

8. The method according to claim 7, wherein the microorganisms capable of producing elemental nitrogen are in the form of a biomass obtainable from the anoxic treatment of wastewater treatment plant, and the Volatile Suspended Solid (VSS) content is from 500 to 5000 mg per litre of aqueous phase.

9. The method according to claim 1, wherein steps i) and ii) take place either in a single reactor, or alternatively, in different reactors.

10. The method according to claim 1, which comprises a further step iii) of recovering the NAP after step ii).

11. The method according to claim 1, wherein step ii) is carried out at a temperature from 5 to 40° C.

12. The method according to claim 1, wherein step ii) is carried out at a pH from 6.5 to 9.

13. The method according to claim 1, which is carried out under a pressure ranging from 101325 to 161325 Pa.

14. A method for removing NOx gases from a gas stream by applying a non-aqueous phase liquid (NAP) to the gas stream wherein the NAP is capable of acting as NOx gas-liquid mass transfer vector, has a molecular weight from 150 to 550 g/mol, a boiling point from 400 to 700 K at 101300 Pa, and a water solubility equal to or lower than 0.1 g/L at 298 K and 101300 Pa; wherein NOx is selected from nitric oxide (NO), nitrogen dioxide (NO₂), and a mixture thereof.

15. The method according to claim 14, in a Chemical Absorption-Biological Reduction (CABR) system.

16. The method according to claim 2, wherein the NAP has a water solubility equal to or lower than 0.1 g/L at 298 K and 101300 Pa.

17. The method according to claim 16, wherein the solvent system comprises an aqueous phase and a NAP, wherein the NAP concentration is from 1 to 60% (v/v) with respect to the total volume of the solvent system.

18. The method according to claim 4, wherein the solvent system comprises an aqueous phase and a NAP, wherein the NAP concentration is from 1 to 60% (v/v) with respect to the total volume of the solvent system.

19. The method according to claim 1, wherein the microbial denitrification is carried out in the presence of an aqueous phase under anoxic conditions by the action of microorganisms capable of producing elemental nitrogen; step ii) is carried out at a temperature from 5 to 40° C. and at a pH from 6.5 to 9.

20. The method according to claim 4, wherein the microbial denitrification is carried out in the presence of an aqueous phase under anoxic conditions by the action of microorganisms capable of producing elemental nitrogen; step ii) is carried out at a temperature from 5 to 40° C. and at a pH from 6.5 to 9.


SEQUENCE LISTING (10 sequences)

SEQ ID NO: 1 - DNA, 17 bp, synthetic construct
  source 1..17: mol_type = other DNA
cctacgggrsgcagcag

SEQ ID NO: 2 - DNA, 15 bp, synthetic construct
  source 1..15: mol_type = other DNA
attaccgcggctgct

SEQ ID NO: 3 - DNA, 19 bp, synthetic construct
  source 1..19: mol_type = other DNA
gtgccagcmgccgcggtaa

SEQ ID NO: 4 - DNA, 20 bp, synthetic construct
  source 1..20: mol_type = other DNA
ggactachvgggtwtctaat

SEQ ID NO: 5 - DNA, 18 bp, synthetic construct
  source 1..18: mol_type = other DNA
cctaytggccgccrcart

SEQ ID NO: 6 - DNA, 18 bp, synthetic construct
  source 1..18: mol_type = other DNA
gccgccgtcrtgvaggaa

SEQ ID NO: 7 - DNA, 19 bp, synthetic construct
  source 1..19: mol_type = other DNA
gacaagnnntactggtggt

SEQ ID NO: 8 - DNA, 17 bp, synthetic construct
  source 1..17: mol_type = other DNA
tgnccrtgngcngcngt

SEQ ID NO: 9 - DNA, 19 bp, synthetic construct
  source 1..19: mol_type = other DNA
cgctgttchtcgacagyca

SEQ ID NO: 10 - DNA, 20 bp, synthetic construct
  source 1..20: mol_type = other DNA
atrtcgatcarctgbtcgtt